(19) United States
(12) Patent Application Publication
(10) Pub. No.: US 2002/0171886 A1
(43) Pub. Date: Nov. 21, 2002

(54) Automatic control plane recovery for agile optical networks

(76) Inventors: Quansheng Wu, Nepean (CA); Ling-Zhong Liu, Ottawa (CA)

Correspondence Address: MARKS & CLERK, P.O. BOX 957, STATION B, OTTAWA, ON, K1P 5S7, CA

(21) Appl. No.: 10/086,698

(22) Filed: Mar. 4, 2002

Related U.S. Application Data
(60) Provisional application No. 60/273,547, filed on Mar. 7, 2001.

(51) Int. Cl. H04B 10/08; H04B 10/20; H04J 14/00

(52) U.S. Cl. 359/110; 359/118

(57) ABSTRACT

This application proposes a solution for providing fast auto-recovery of the control plane network against a control link failure in an optical communications network. The described solution applies to both protected and unprotected control channels. If a control channel is protected, the solution is triggered only when the protection control channel cannot resume the connectivity. In a control link failure situation each node in a neighboring pair attempts to find an alternate control route before informing the network manager of the link failure. If an alternate route is established, the control plane is quickly re-established without involving system resources.

This invention claims the benefit of U.S. Provisional Application No. 60/273,547 filed Mar. 7, 2001.

### FIELD OF THE INVENTION

This invention relates to communications systems, and more particularly to the automatic recovery of control signals in the event of a control link failure between neighboring nodes in an optical communications system.

### BACKGROUND

Future agile optical networks will need a reliable and robust control network to ensure quality service. These control networks are made up of multiple control channels. The control network may be implemented either in-band, in which the control information is embedded in the data channel, or out-of-band, in which the control network uses an independent control channel separated from the data channels. Multiple choices exist to deploy an out-of-band control plane network.

Agile optical networks are expected to quickly and automatically provision lightpath on the request of customers. Successful provisioning depends on two basic functions of the control network. The first function is routing, which automatically updates the optical network topology and related resource information so that a node can compute a route for a lightpath for the request. The second function is signaling, by which the nodes along a route can exchange information to set up or tear down a lightpath without user intervention.

Most of the current control network approaches are based on the extension of the existing Internet Protocols (IP). The standard Internet routing protocols, OSPF (Open Shortest Path First) and IS-IS (Intermediate System to Intermediate System), are extended to exchange optical network routing information and construct the optical routing information database. These protocols rely on the instant and periodic exchange of the link state information between a directly connected (physically or logically) pair of nodes, called neighbors. These protocols ensure the routing functionality of an optical network. The standard signaling protocol, MPLS (Multi-protocol Label Switching), is extended to GMPLS (Generalized MPLS) to support the signaling functionality. This extended protocol uses the routing databases to set up or tear down a lightpath. The GMPLS signaling protocol assumes that the control plane has the same topology as the data plane regardless of whether the control network is in-band or out-of-band. Furthermore, the newly developed LMP (Link Management Protocol) needs at least one control channel to be set up between two neighboring nodes.

The OSPF and IS-IS protocols are limited in that their design is based on the assumption that the data and control (routing) information is transmitted by the same underlying data link, i.e., in-band control. This means that the health of the data plane reflects that of the control plane. In the context of the out-of-band control plane of optical networks, this assumption is not always true. For example, if a control plane is established by an IP network, an intermediate router failure will make the control channel inaccessible, but the data plane on the optical side may still be functioning. This means that the control plane topology no longer reflects the optical data plane topology. Even if the OSPF can ensure the accessibility of the control messages by re-routing, the control network topology is changed because the neighboring relationship has been changed in the control plane. The data and control information no longer match each other.

The robustness of optical networks depends on the ability to quickly re-establish the control plane network and neighbor relationship when failures occur in the control channels. Current control networks rely on reporting any link failure to the IGP (Interior Gateway Protocol) engine. The IGP will flood the network with topology changes potentially, reducing the stability of the network.

### SUMMARY OF THE INVENTION

The present invention can apply to both in-band and out-of-band control channels. It could be an in-fiber control plane in which the control information is transported by a dedicated wavelength or sub-wavelength in a data channel. It could be an out-of-fiber control plane in which the control information is exchanged by a network that does not use the fibers connecting the optical nodes. It could be a mixture of in-fiber and out-of-fiber connections working together to form a control network. The invention is suitable for all cases. The reliability of the control network can be reinforced by deploying redundant protection control links between the optical nodes. The robustness of the control network relies on the capability of the control network to automatically recover from control link failures.

This application provides a solution for fast auto-recovery of the control plane network in a control link failure. This solution applies to both protected and unprotected control channels. If a control channel is protected, this solution is triggered only when the protection control channel cannot resume the connectivity; i.e. when the protection channel has failed as well

Therefore, in accordance with a first aspect of the present invention, there is provided a method of performing automatic recovery of a control plane network in the event of a control link failure in an optical communications system comprising: detecting a failure in a control link between neighboring switch nodes; searching for an alternate route between the neighboring switch nodes; if an alternate route is located, switching the control plane to the alternate route, and notifying respective switch nodes of the alternate route.

In accordance with a second aspect of the invention, there is provided a system for performing automatic recovery of a control plane network in the event of a control link failure in an optical communications system comprising: a link manager for detecting a failure in a control link between neighboring switch nodes; and a control channel manager for searching for an alternate route between the neighboring switch nodes, for switching the control plane to the alternate route if an alternate route is located, and for notifying respective switch nodes of the alternate route.

### BRIEF DESCRIPTION OF THE DRAWINGS

The invention will now be described in greater detail with reference to the attached drawings wherein;

FIG. 1 illustrates the software architecture of an automatic control channel recovery scheme; and

FIG. 2 illustrates one embodiment of a control plane network.

### DETAILED DESCRIPTION OF THE INVENTION

The basic underlying principle of the present invention is to maintain the neighbor relationship when a control channel between a pair of optical nodes goes down or out of service. Instead of reporting the failure immediately to the IGP engine, which will, in turn, drop the neighbor relationship, the control plane will try to establish an alternate channel through an alternate route by itself. Once such a channel is set up successfully, the control plane switches the failed primary channel silently and transparently to the alternate one without notifying the IGP engine and other upper layer applications, such as GMPLS. This fast and transparent recovery significantly reduces IGP flooding, thus improving the stability of the control networks. Furthermore, the alternate control channel can be treated as a temporary repair of the control network. Once the failure in the primary channel has been repaired, the alternate control channel can be switched back to the primary channel, without detection by the other control network applications. The alternate control channel can then be torn down. This switch-back can be triggered manually by an operator, or automatically when the primary control channel has been repaired.

This solution applies to all of the possible control network deployments: in-fiber, out-of-fiber and a mixture of the two. It also applies to protected control channels, when the protection scheme fails to maintain control channel connectivity.

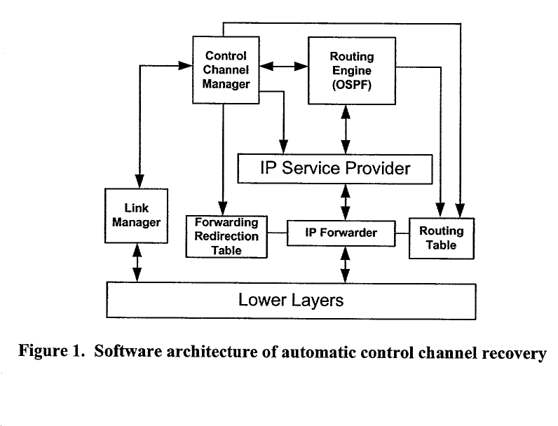

FIG. 1 shows a possible implementation of the proposed solution.

The key components of this implementation are shown in FIG. 1 and are described in the following discussion.

The LM (Link Manager) is responsible for managing and monitoring the control channels that connect pairs of nodes. The LM interacts with the lower layer mechanisms, such as LMP (Link Management Protocol), to detect the health of the control channels. Once a failure in a control channel has been detected, the LM will report the failure to the CCM (Control Channel Manager) along with the identifier of the failed control channel. Once a control channel is re-established, the CCM notifies the LM that the control channel is now back in service.

The CCM manages the control channels, and is able to set up or tear down control channels. It interacts with the routing engine to maintain knowledge of the control network topology. It maintains two databases: the Routing Table that holds the initial topology of the control network, and the FRT (Forward Redirection Table) that is dynamically updated with the IP forwarding interfaces of the local nodes.

The FRT is a mapping table of the IP forwarding interfaces of the local nodes. It provides information to the IPF (IP Forwarder) on how and where to redirect the IP traffic.

The IPF forwards the IP packets according to the information from the Routing Table and the FRT. When the IPF receives an IP packet to forward, it consults the routing table by the destination IP address, and gets an outgoing forwarding interface. Before forwarding the packet, the IPF gets the updated outgoing interface from the FRT, then forwards the packet to that interface. A more detailed forwarding procedure description is given in the example to follow.

An IPSP (IP Services Provider) offers IP services to the upper layer applications. In addition to normal IP services, IPSP enables applications to establish or tear down an IP tunnel, e.g. IP-in-IP tunnel.

The OSPF and the Routing Table update the routing and forwarding information.

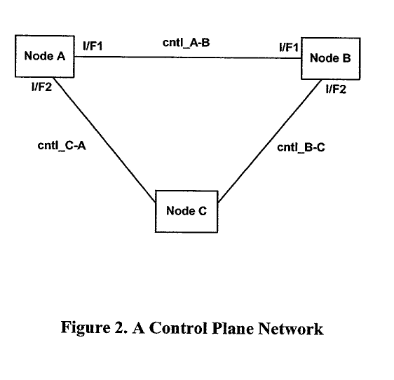

FIG. 2 shows as an example of the implementation of this solution in a control plane network. In this configuration, three optical switches, nodes A, B and C, are connected, by fibers to form a ring. Bi-directional control channels are established mirroring the data plane topology (cntl_A-B, cntl_B-C and cntl_C-A). The control channels are established through in-fiber connections using IP over SONET technology. The IP stack on the node ensures that the control channel has IP connectivity. An optical extended IGP OSPF maintains two topology databases: the CNLSDB (Control Network Link State Database), and OLSDB (Optical Data Plane Network Link State Database). In this configuration, the Routing Table and the FRT are shown in the tables 1 and 2 respectively.

TABLE 1
Routing Table of Node A

| | Outgoing |
|---|---|
| Destination | Interface |
| Node B | I/F 1 |
| Node C | I/F 2 |

TABLE 2
Forward Redirection Table of Node A

| From Interface | To Interface |
|---|---|
| I/F 1 | I/F 1 |
| I/F 2 | I/F 2 |

When a failure occurs on the control channel between node A and B (e.g. the fiber is cut, or the laser is burnt out), the control channel connectivity between node A and B goes down. The LM on node A or node B will detect the failure, and report it to its CCM with the control channel identifier. Instead of reporting the failure immediately to the OSPF (that would instantly trigger flooding the network with updates), each CCM will try to establish an alternate channel by itself. The CCM on the node with the larger node ID (node A), looks up the CNLSDB of OSPF, and tries to find a route between node A and B that excludes the link between node A and B (because it has failed). In this example, the route A-C-B can be found. The CCM of node A then creates an IP-in-IP tunnel through the interface I/F2 of node A to the interface I/F2 of node B. Once the tunnel is set up successfully, the CCM of node A will send a message through the tunnel to the CCM of node B to request it to set up an IP-in-IP tunnel back to node A. Once the two tunnels are set up successfully, the CCMs on both nodes switch the control channel to the IP tunnels. The CCMs then update the FRTs to map the previous interface (I/F1) onto the IP tunnel interface (I/F_Tunnel_{—}1).

The updated FRT of node A is shown in table 3. Similarly, the CCM on node B updates the FRT on node B. The routing tables on both nodes stay unchanged.

TABLE 3
Updated Forward Redirection Table of Node A

| From Interface | To Interface |
|---|---|
| I/F 1 | I/F_Tunnel_1 |
| I/F 2 | I/F 2 |

The CCMs then notify the corresponding LMs on both nodes that the control channel between A and B has been re-established with the same control channel identifier. The replacement of the control channel is transparent to the LM and to the OSPF.

This procedure is based on the assumption that the time to establish the IP tunnel and to update FRT would be much shorter than the OSPF's “hello message timeout” (typically 30 seconds). This solution prevents the OSPF from flooding the network with topology changes caused by a link failure. As the FRT is built into the IP forwarder, the forward redirection is transparent to the upper layer IP applications. It is worth noting that the CCM saves the previous control channel information. When the failure has been repaired, the CCM can switch the control channel back to the previous control channel by just restoring the FRT. This switch-back can be done automatically by CCM, or manually triggered by an operator. After the switch-back is done, the operator can choose to maintain the IP tunnel for later use, or tear it down and release the resources. The CCM can be configured to perform these operations automatically.

If the CCM cannot establish an alternative IP tunnel between A and B, it will notify OSPF of the link failure, which, in turn, will flood it into the network.

As a possible variation to the implementation described above, the IP tunnel can be replaced by an LSP (Label Switched Path), using MPLS protocol. In this case, an MPLS data plane must be implemented on all the nodes.

This solution can be applied directly to control network protection channels for a fast and transparent switch-over of an active control channel to a redundant one. The CCM keeps the active and redundant control channel information. When a failure occurs on the active channel, the CCMs of the node-pair update the FRTs to redirect the control traffic from the active channel to the back-up one. Again, the switch-back can be easily accomplished by updating the FRTs appropriately.

Although particular embodiments of the invention have been described and illustrated, it will be apparent to one skilled in the art that numerous changes can be made without departing from the basic concept. It is to be understood, however, that such changes will fall within the full scope of the invention as defined by the appended claims.

We claim:

1. A method of performing automatic recovery of a control plane network in the event of a control link failure in an optical communications system comprising:
detecting a failure in a control link between neighboring nodes;
searching for an alternate route between the neighboring nodes;
if an alternate route is located, switching the control plane to the alternate route; and
notifying respective switch nodes of the alternate route.

2. The method according to claim 1 wherein said control plane network employs Internet Protocol (IP) technology.

3. The method according to claim 2 wherein said control plane network is on an in-band link.

4. The method according to claim 3 wherein said in-band link is a wavelength channel carried on an optical fiber.

5. The method according to claim 2 wherein said control plane network is on an out-of-band link.

6. The method according to claim 2 wherein said alternate route is an IP tunnel between said neighboring nodes.

7. The method according to claim 1 wherein, if said link failure is repaired, said control link is switched back to the original link.

8. The method according to claim 7 wherein said control link is switched back to said original link automatically.

9. The method according to claim 7 wherein said control link is switched back to said original link manually by an operator.

10. The method according to claim 1 wherein, if an alternate route is not located within a preset interval, a search is conducted for an alternate route through the complete network.

11. The method according to claim 1 for use in a protected system wherein the control link has a predefined alternate route.

12. The method as defined in claim 1 for use in an unprotected system wherein the control link does not have a predefined alternate route.

13. A system for performing automatic recovery of a control plane network in the event of a control link failure in an optical communications system comprising:
a link manager for detecting a failure in a control link between neighboring nodes; and
a control channel manager for searching for an alternate route between the neighboring nodes, for switching the control plane to the alternate route if an alternate route is located, and for notifying respective nodes of the alternate route.

14. The system as defined in claim 13 wherein said control channel manager has an information database for maintaining information on the control network.

15. The system as defined in claim 14 wherein said information database stores a forwarding redirection table that maps forwarding interfaces.

16. The system as defined in claim 13 having an IP forwarder for forwarding information from a routing table and the forwarding redirection table.
